(19) United States
(12) Patent Application Publication
(10) Pub. No.: US 2012/0052001 A1
(43) Pub. Date: Mar. 1, 2012

(54) ENERGY STORAGE AND GENERATION OF HYDROGEN AND HEAT ON DEMAND

(76) Inventors: Jerry M. Woodall, Westpoint, IN (US); Go Choi, West Lafayette, IN (US)

(21) Appl. No.: 13/218,033

(22) Filed: Aug. 25, 2011

Related U.S. Application Data
(60) Provisional application No. 61/377,180, filed on Aug. 26, 2010.
(60) Provisional application No. 61/377,195, filed on Aug. 26, 2010.

(51) Int. Cl. C01B 3/08; C01F 7/02; C09K 3/00

(52) U.S. Cl. 423/627; 423/657; 252/184

(57) ABSTRACT

A composition for splitting water into hydrogen and a hydroxide component, the composition comprising a solid-state component including at least one of aluminum and tin and a liquid metal alloy that is capable of at least partially dissolving the solid-state component, the liquid metal alloy including at least one of gallium and indium.

### CROSS-REFERENCE TO RELATED APPLICATIONS

This application is related and claims priority to U.S. Provisional Patent Application Ser. Nos. 61/377,180 and 61/377,195, both of which were filed on Aug. 26, 2010. The complete and entire disclosures for both of these respective applications are hereby expressly incorporated herein by this reference.

### BACKGROUND OF THE INVENTION

The present invention relates generally to the field of energy storage and power generation and more particularly to the use of hydrogen in power generation.

For centuries, large scale power generation has been dominated by the use of non-renewable resources, such as coal, oil and gas. In the latter decades of the 20^{th} century, concerns began to mount regarding the limits to these non-renewable resources, especially oil. Concurrent with the concerns over depletion of these power generation resources has been the growing fear of the effects of emissions not only from the use of, but also from the production of, the non-renewable resources. While the debate over the contribution of burning fossil fuels to the phenomenon of global warming rages, there is no question that the production and use of coal and oil are significant sources of air pollution.

The fear of scarcity and deleterious environmental effects has generated growing pressure to develop so-called “alternative” power or energy sources, especially from renewable sources. Thus, significant effort has gone into developing sun, wind and wave power generation systems. Thus far, these renewable energy sources have been demonstrated to have value in large scale power generation, such as for supplying electricity to the grid. For obvious reasons, these renewable resources are inadequate for small power supply needs, such as to power a cell phone or run an automobile. For smaller power needs, rechargeable batteries or power cells have been developed and utilized with good success. Of course, these rechargeable electrical sources still rely upon large scale electricity generation, which is overwhelmingly coal or nuclear based.

Beginning in the last third of the 20^{th} century and continuing into the third millennium significant time, money and energy has been devoted to developing so-called “green” sources of power and energy that are renewable and have a much lower environmental impact than their fossil fuel cousins. One proposed solution has been to use hydrogen as a fuel. Hydrogen-fuel cell and hydrogen-internal combustion engine (ICE) technology has been successfully demonstrated for use in powering an automobile. However, many drawbacks inherent with the generation, storage and transport of hydrogen have hampered its wide-spread development and usage. One significant problem has been that it takes a significant amount of energy to extract hydrogen from water. Another problem is that room-temperature hydrogen is difficult to store since it must be strongly compressed in large, heavy pressure-safe storage tanks, or maintained in a liquefied form in cryogenically cooled tanks. In either case, the storage requirements make use of hydrogen in automobiles problematic and in much smaller apparatuses virtually unthinkable.

On the positive side, combustion of hydrogen is perhaps the most “green” power source possible. The byproduct or “exhaust” of hydrogen combustion is water and hydrogen and not the carbonaceous gases that are exhausted from combustion of more traditional fuels.

There is a need for hydrogen generation systems and processes that avoid the inherent problems with current technology, namely storage and extraction.

There is also a need for on-demand hydrogen generation systems and processes that are able to sustain extraneous exposure to moist air and/or water without being rendered ineffective for water-splitting applications.

The present invention is intended to improve upon and resolve some of these known deficiencies within the relevant art.

### SUMMARY OF THE INVENTION

In accordance with one aspect of the present invention, a composition for splitting water into hydrogen and a hydroxide component is provided. The composition comprises a solid-state component and a liquid metal alloy that is capable of at least partially dissolving the solid-state component. In certain specific embodiments, the solid-state component includes at least one of aluminum (Al) and tin (Sn) and the liquid metal alloy includes at least one of gallium (Ga) and indium (In). Also in still other specific embodiments, the solid-state component includes at least one of aluminum (Al) and tin (Sn) and the liquid metal alloy includes only gallium. In still other embodiments, zinc (Zn) and/or silicon (Si) may also be included as part of the solid-state component.

In accordance with another aspect of the present invention, an energy storage and on-demand hydrogen and energy generation process is provided. The process comprises: mixing aluminum with tin to form a solid-state component; soaking the solid-state component in a liquid metal alloy containing at least one of gallium and indium (or just gallium) to form a liquid-solid ensemble; introducing water to the liquid-solid ensemble to cause hydrogen and heat to be produced; and collecting the produced hydrogen and/or heat (depending on the target application).

In accordance with still another aspect of the present invention, a process for controlling the generation of hydrogen from water is provided. The process comprises mixing aluminum with tin to form a solid-state component; mixing aluminum with tin to form a solid-state component; partially dissolving the solid-state component in a liquid metal gallium-indium alloy or gallium catalyst; and forming hydrogen, heat and a hydroxide of the solid-state component by introducing water to the partially dissolved solid-state component. Once the partially dissolved solid-state component is introduced into water, hydrogen and hydroxide formation with heat occurs when the liquid agent proximate to the grain boundaries partially dissolves the solid-state component. At the boundary between the water and the liquid agent, the solid-state component dissolved in the liquid agent splits the water, thereby forming hydrogen, heat and a hydroxide of the solid-state component. This process continues until all or most of the solid-state component is reacted. In a specific embodiment, the liquid metal alloy comprises between about 70% and about 100% by weight gallium and up to about 30% by weight indium.

In accordance with yet another embodiment, the present invention is directed to an on-demand process for generating energy by splitting water into hydrogen and a hydroxide component. According to this embodiment, a liquid phase alloy component is formed by mixing together about 13.6% by weight gallium (Ga), about 4.4% by weight indium (In) and about 2.0% by weight tin (Sn). A solid-like alloy is then formed by mixing about 80% by weight aluminum (Al) with the liquid phase alloy component. An acceptable temperature for splitting the water ranges from about 10° C. to about 90° C. To cause the water to split, a liquid Ga, In and Sn component dissolves the Al component. In turn, the Al component in the liquid Ga, In and Sn component reacts with the water and splits it into hydrogen.

In accordance with still another aspect of the present invention, a composition for splitting water into hydrogen and a hydroxide component comprises a solid-state component having from about 0.68% to about 95% by weight solid aluminum grains and a liquid metal alloy having from about 3.4% to about 67.56% by weight gallium, from about 1.1% to about 11% by weight indium and from about 0.5% to about 21.83% by weight tin.

### BRIEF DESCRIPTION OF THE DRAWINGS

The above-mentioned aspects of the present invention and the manner of obtaining them will become more apparent and the invention itself will be better understood by reference to the following description of the embodiments of the invention taken in conjunction with the accompanying drawings, wherein:

FIG. 1 is a flow chart showing a closed cycle renewable energy supply using a passivation capable solid-state material, an oxidizer and a passivation preventing agent to produce hydrogen and heat;

FIGS. 2-3 are diagrams showing equilibrium phases for aluminum-gallium mixtures;

FIG. 4 is a diagram showing an equilibrium phase for a gallium-indium mixture;

FIG. 5 is an apparatus for measuring the reaction rate of experimental methods conducted in accordance with the present invention;

FIGS. 6-8 are graphical representations of yield versus time and comparing data points for saltwater and distilled water reactions in accordance with experimental teachings conducted along the lines of the present invention;

FIGS. 9a and b are images of 95% by weight aluminum, 3.4% by weight gallium, 1.1% by weight indium and 0.5% by weight tin alloy microstructures in accordance with the present invention; and

FIGS. 10-12 are graphical representations of yield versus time and comparing data points for saltwater and distilled water reactions in accordance with experimental teachings conducted along the lines of the present invention.

### DETAILED DESCRIPTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Before discussing the specifics of the present invention, it is initially noted and should be understood and appreciated herein that the teachings of the present invention are intended to apply to both freshwater and seawater applications. Moreover, in terms of the disclosed embodiments including tin, those of skill in the art will understand that since tin is very stable and does not react in water, it works to passivate the aluminum so that the solid-state alloy can be stored in both air and water and then used when needed on-demand.

As will be explained in detail herein, the present invention is intended to provide a composition that is capable of efficiently splitting water into hydrogen, heat, and a hydroxide component. The composition may be efficiently produced in a substantially or completely recyclable manner and allows for a controlled reaction and on-demand production of hydrogen, thereby eliminating storage and extraction problems typically associated with using hydrogen as a primary fuel.

In accordance with certain aspects of the present invention, the aluminum is contained in a solid-state like material with a liquid agent or catalyst capable of partially dissolving the aluminum and is proximate to the aluminum grain boundaries so that the dissolved aluminum reacts with the water at the boundary with the liquid agent to split the water into hydrogen, heat, and aluminum hydroxide. The hydrogen and the heat may be provided to a power generation element, such as a combustion engine in a vehicle or a steam driven turbine. More broadly, hydrogen conversion systems and processes of the present invention may be combined with apparatuses capable of converting hydrogen and heat into electrical, mechanical or thermal power.

It should be understood and appreciated herein that aluminum can be hydrolyzed in the presence of liquid gallium to produce aluminum hydroxide, hydrogen and heat. While aluminum oxidizes at low or room temperature, it also forms a passivating oxide that inhibits further reaction. Gallium has a tendency to oxidize its surface when exposed in air; however, the oxide layer will prevent further oxidation beneath it. As such, gallium serves as a solvent that inhibits the passivating nature of the aluminum oxide. To this end, gallium and gallium-indium alloys are desirable in accordance with certain aspects of the present invention, particularly because they become liquid at low temperatures and have low vapor pressures, thereby allowing wide temperature windows for aluminum oxidation reactions. For instance, liquid gallium (or a suitable liquid gallium-indium alloy) has an atomic percentage of solubility with aluminum at 100° C. of approximately 9, which allows a small fraction of the aluminum to dissolve in the solvent.

The process for controlled oxidation of aluminum using water as the oxygen supplying reagent and gallium as the passivating oxide inhibitor, follows these reaction equations:

2Al+6H₂O→2Al(OH)₃+3H₂+Δ₁ (1)

2H₂+O₂→2H₂O+ΔE₂ (2)

where ΔE₁ represents the heat value of the reaction and equals 430.6 kJ/mole Al=15.9 kJ/g of Al, and ΔE₂ represents the combustion energy value that hydrogen forms by the reaction and equals 286 kJ/mole H₂=429 kJ/mole Al=15.9 kJ/g of aluminum.

This process is renewable because the Al(OH)₃ produced can be converted back into aluminum using reactions such as the following:

2Al₂O₃+ΔE₃→4Al+3O₂ (3)

where ΔE₃=877 kJ/mole of Al=32.5 kJ/g of aluminum. It should be noted that practical processing efficiency of converting the aluminum hydroxide back to Al is 68% via the Hall electrolysis process.

The energy density of aluminum as a fuel compares extremely favorably to other known technologies, as demonstrated by the following Table 1:

TABLE 1

| | Energy | | | Net | |
|---|---|---|---|---|---|
| | Density | | Efficiency | Power | Emission |
| Fuel | (kJ/g) | Engine | (%) | (kJ/g) | Products |
| Aluminum | 31 | Stirling or | 25-50 | 7.8-15.5 | Al(OH)₃ |
| | | Fuel Cell | 25 | 7.8 | H₂O |
| Gasoline | 47.5 | Internal | 20-25 | 9.5-11.9 | CO₂, CO, |
| | | Combustion | | | NOₓ, SOₓ, etc. |
| Methanol | 23 | Reformer + | 30-40 | 6.9-9.2 | H₂O, CO₂, CO |
| | | Fuel Cell | | | |

As those in the art will understand and appreciate, reaction and emission products from aluminum fuel are fully recyclable. In addition, water may be recycled to provide additional oxidizer for the aluminum in the reaction process, while aluminum hydroxide is environmentally benign and readily recyclable into reusable aluminum to generate hydrogen. Moreover, since gallium, indium and tin are inert, substantially all of the liquid or solid alloy component contained in the aluminum-alloy mixture remains after the aluminum has been consumed. The liquid alloy component may be re-used and is hence nearly 100% recyclable.

The overall efficiency of the aluminum fuel protocol should also consider the efficiency of recycling the Al(OH)₃ back into usable aluminum. Using the Hall process of thermodynamics, the cycle efficiency is about 68%, where cycle efficiency is the energy generated by the oxidation of the aluminum divided by the energy required to recycle the aluminum. This cycle efficiency in Table 1 assumes that only 25% of the available energy of the oxidation process is captured as useful power. Obviously, if more energy is captured (such as the heat generated by the reactions in Equations 1 and 2) then the recycle efficiency also improves.

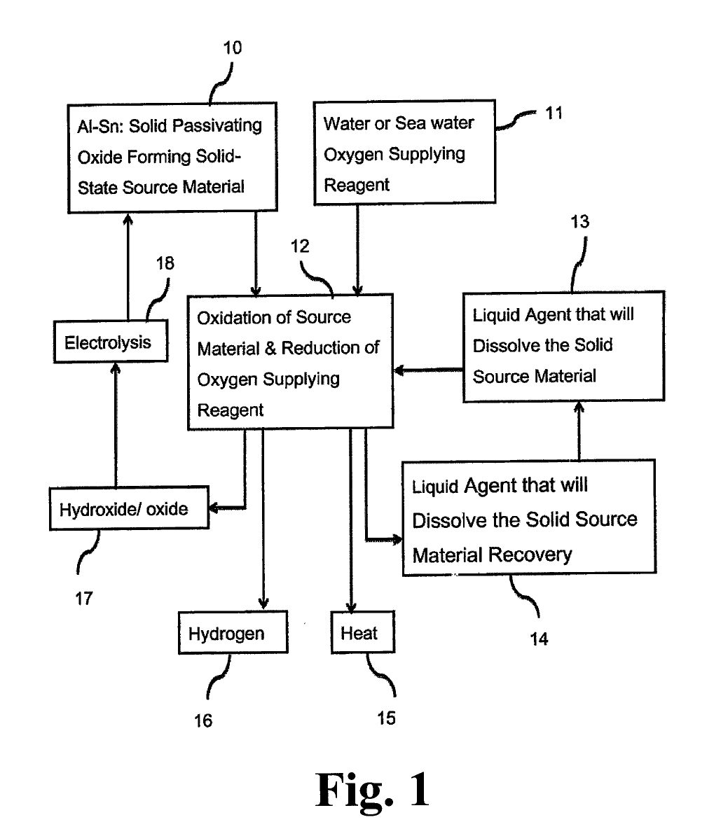

FIG. 1 is a flow chart showing a known closed cycle renewable energy supply using an oxide passivated solid-state material, an oxygen supplying reagent and a liquid agent capable of diffusing the solid-state material agent to produce hydrogen and heat. In accordance with this system, a source of solid-state material 10 (i.e., an Al—Sn: solid passivating oxide forming solid-state source material) that oxidizes in the atmosphere at a low temperature and a reagent source 11 (i.e., a freshwater or seawater supplying reagent) that can supply oxygen for the reaction are combined in a container 12 in the presence of a liquid agent capable of dissolving the solid-state material 13. The solid-state material 10 ordinarily forms an oxide coating upon exposure to the atmosphere, completely passivating the surface and inhibiting further oxidation. At a temperature sufficient to keep the agent 13 in a liquid state, the agent dissolves a portion of the solid-state material, thereby preventing formation of the oxide. The solid-state material dissolved in the liquid agent will oxidize while the oxygen supplying reagent will be reduced.

Four products result from this chemical process: heat 15 and hydrogen 16 which are co-generated energy outputs; recovered agent 14 obtained from the agent 13 that is not otherwise consumed during the reaction; and an oxide reaction product 17 (i.e., hydroxide/oxide). The reaction product 17 can be generally converted back into the solid-state material 10 through an electrolysis procedure 18, which itself usually requires the application of electrical current and heat using a Hall reactor, for instance.

In accordance with one embodiment, the solid-state material 10 is aluminum metal, the reagent 11 is liquid water, the agent 13 is liquid gallium and the oxide reaction product 17 is an aluminum hydroxide. In accordance with certain prior art embodiments, the aluminum can be dissolved in a liquid solvent, such as gallium, at room temperature. The present inventors have found, however, that this specific approach has drawbacks in terms of the cost and complexity needed to maintain suitable control of the reaction.

In order to avoid the drawbacks, the present inventors have developed a system that provides a solid-like mixture of solid-state oxide forming source material and liquid agent solvent. The reaction of that solid-like mixture with an oxidizer containing hydrogen produces hydrogen gas, heat and a hydroxide of the source material, and can be used to produce useable forms of energy, such as electricity, mechanical energy and/or heat. In the context of the present invention, the term “solid-like mixture” means a mixture in which the oxide forming source material is in its solid-state form and the liquid agent solvent is substantially in the liquid state. This solid-like mixture is non-volatile and easy to store (for instance, it can be stored in pellets that can be introduced into a water-filled chamber and provide a large surface area for reaction and an elegant means for controlling the rate of the reaction).

In accordance with certain aspects of the present invention, the solid-state oxide forming source material is solid aluminum because it is readily available and inexpensive, as well as it has an inherent thermo-chemical ability to react vigorously at room temperature with water as the oxidizer. Water is a useful oxidizer because it is readily available, inert and easy to obtain and store. Other solid source materials and oxidizers may be contemplated that react together; however, the selection of the liquid agent or catalyst should be intertwined with the selection of the source material and the oxidizer. To this end, the agent must be able to partially dissolve the source material and it must be inert to the oxidizer. In accordance with certain aspects of the present invention, the liquid agent is one of gallium, gallium and indium, gallium, indium and tin or gallium and tin, because it is non-reactive to water as the oxidizer, it readily and partially dissolves aluminum, and it has a solid to liquid phase transition temperature near room temperature. Of course, if a different source material and/or oxidizer are selected, then a different liquid agent may be required. It should be understood and appreciated herein that, in accordance with certain embodiments, zinc (Zn) and/or silicon (Si) may also be used as the solid state source material without straying from the teachings of the present invention

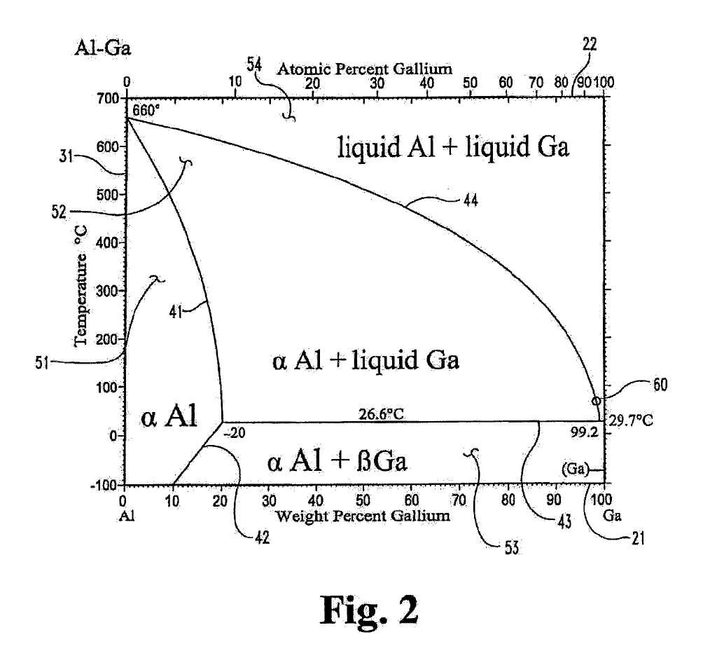

Moving now to FIG. 2, an equilibrium phase diagram for aluminum-gallium mixtures is shown. The lower horizontal axis 21 corresponds to the weight percent of gallium in a mixture of aluminum and gallium, while the upper horizontal axis 22 relates the atomic percent in the mixture. The vertical axis 31 shows the temperature in degrees Celsius. Line segments 41, 42 and 43 show the boundaries between the different solid phases in the diagram. Line segment 41 corresponds to the boundary between the equilibrium solid aluminum (α Al) phase in the region 51 and the equilibrium solid aluminum-liquid gallium mixture (α Al+liquid Ga) in region 52. Similarly, line segment 42 shows the boundary between equilibrium solid aluminum (α Al) phase in the region 51 and the equilibrium solid aluminum-solid gallium mixture (α Al+βGa) in region 53. Line segment 43 is at the boundary between the equilibrium solid aluminum-solid gallium mixture (α Al+β Ga) in region 53 and the equilibrium solid aluminum-liquid gallium mixture (α Al+liquid Ga) in region 52. Finally, line segment 44 defines the boundary between the equilibrium solid aluminum-liquid gallium mixture (α Al+liquid Ga) in region 52 and the equilibrium liquid aluminum-liquid gallium mixture (liquid Al+liquid Ga) in region 44. It can be appreciated that the region 52 (α Al+liquid Ga) is defined as the entire region bounded by the line segments 41, 43 and 44.

The mixture generally operates using a liquid gallium phase that contains a small amount of dissolved aluminum, as represented by the point 60 in FIG. 2. In accordance with one illustrative embodiment, 0.466 g Al is dissolved into 19.916 g Ga, so that the resulting solution is about 98% Ga and 2% Al. This mixture requires a macroscopic liquid phase of the solvent, which is used to dissolve the solid phase aluminum to thereby allow the reaction of Equation 1 to proceed until substantially all of the dissolved aluminum is consumed, the liquid solution of gallium plus aluminum is removed, or the water is removed.

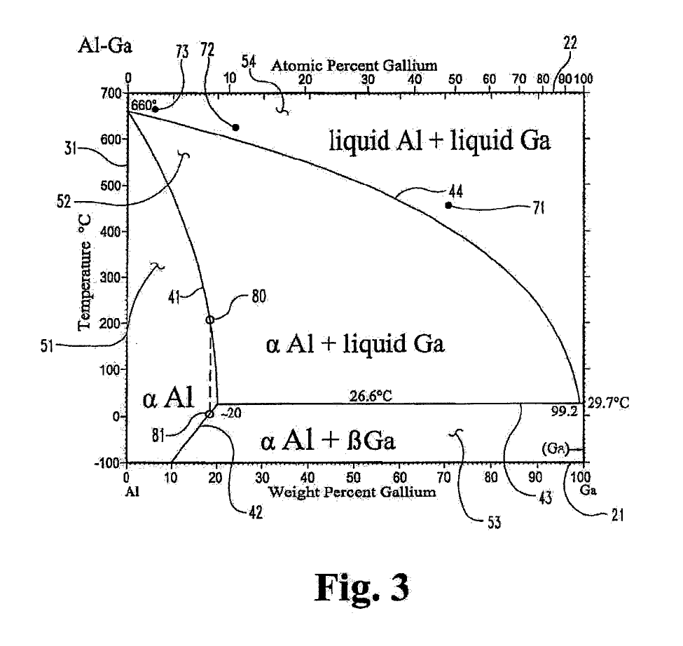

In accordance with alternative embodiments, the macroscopic liquid phase of the solvent is eliminated by enabling the production of a solid mixture of aluminum, a microscopic liquid phase of the solvent proximate to the grain boundaries of the solid aluminum phases. This solid-like mixture is achieved by combining a desired ratio of aluminum and gallium in an inert reaction chamber (i.e., non-reactive to either constituent) and in a low moisture inert atmosphere to insure minimal oxidation of the aluminum. In certain embodiments, the reaction chamber is formed of stainless steel, while the atmosphere is a mixture of nitrogen (N₂) and hydrogen (H₂). The mixture of aluminum and gallium is heated sufficiently such that the entire mixture is a liquid in region 54 of the phase diagram shown in FIG. 3. The mixture is then cooled at a controlled rate, achieving a solid-like mixture with evidence of a macroscopic liquid phase proximate to the grain boundaries.

The equilibrium phase diagram of FIG. 3 suggests that the mixture should be solid-liquid slush if the cooled composition is in region 52 or a solid-solid alloy if the cooled composition is in region 53. However, the cooling profile is designed to achieve a solid-like mixture of solid aluminum and liquid gallium, and incorporated as microscopic “veins” or “channels” of liquid gallium inside a solid aluminum matrix to form a solid-like mixture. Additionally, the solid-liquid aluminum-gallium mixture need not be an equilibrium solution, since quenching of the liquid-liquid aluminum-gallium mixture can achieve a non-equilibrium mixture.

In one specific example, a mixture of about 28% (twenty-eight percent) aluminum and about 72% (seventy-two percent) gallium by weight were mixed together in an inert reaction chamber at a temperature in excess of 400° C., as identified by point 71 in region 44 of the phase diagram in FIG. 3. This aluminum-gallium liquid mixture was then cooled at room temperature at a controlled cooling rate to achieve a solid-like aluminum-gallium mixture that is largely free of macroscopic liquid gallium phase and that includes a mixture of non-equilibrium aluminum-gallium solid matrix with veins of liquid gallium proximate to the solid aluminum grain boundaries.

In a more specific process, 150 g of Al pellets were placed in a stainless steel container having a volume of about 1 cup. Then 385 g of liquid gallium was poured over the aluminum. Because the aluminum is less dense than the gallium, it has a tendency to float. In order to counteract this tendency, in the specific example ½ cup stainless steel container was half filled with liquid gallium and the ½ cup container was placed inside the larger (1 cup) container so that the smaller container rests inside the larger and holds the aluminum beneath the surface of the liquid gallium. In larger scale practice it is expected that other methodologies will be created to maintain intimate contact between the constituent Al and Ga during the baking cycle, such as by continuous stirring or agitation.

The containers were placed inside a furnace and a nitrogen atmosphere is established. The furnace was operated at 450° C. for ten (10) hours. The heated composition was then cooled according to different protocols depending upon the desired final state of the mixture. In one protocol, the furnace was powered down and the mixture cooled within the furnace as the furnace itself cools. The inert atmosphere was maintained until the mixture had reached room temperature, at which point the mixture had solidified and the aluminum was not susceptible to appreciable oxidation in a moisture-containing atmosphere. In a second protocol, the furnace was set to achieve a controlled cooling of 1° C. per minute. Again, the inert atmosphere was terminated at room temperature.

In a third protocol, the container with the mixture was removed from the furnace and the liquid mixture was quickly poured into an inert bath. In one embodiment, the bath was liquid nitrogen, while in yet another embodiment the bath was silicone oil at cryogenic temperatures. In still another embodiment, the bath was a room temperature mineral oil.

The above-described process was used to produce the 28/72 mixture (i.e., 28% Al and 72% Ga) as well as 56/44 and 70/30 Al to Ga mixtures. These solid-like mixtures are non-volatile and do not react significantly with air. The resulting solid-like mixtures are also stable and remain substantially non-volatile and substantially non-reactive to air even at elevated temperatures approaching 100° C. This attribute makes the solid-like aluminum-gallium mixtures very usable as a stable fuel source for power generation. To use the mixture as a fuel it is only necessary to bring the mixture into contact with a liquid oxidizer that contains hydrogen, such as water, which causes the mixture to react according to Equation 1 above. This reaction exhibits a governed rate of reaction with no flash point. If the reaction is allowed to complete the reaction products include aluminum hydroxide powder, a liquid which is predominantly gallium (if the temperature is higher than 20° C. in accordance with the phase diagram of FIG. 3), hydrogen gas and heat.

In accordance with certain embodiments, the solid-like aluminum-gallium mixture is processed to take the form of spherically-shaped pellets having diameters greater than about 10 mm. The pellets may be formed using a shot tower, or other known manner for shaping solid feed material into pellets. When the pellets are dropped into a reservoir of the liquid oxidizer, the spherical shape provides a large surface area for the reaction to proceed. The rate of the reaction may be controlled by controlling the introduction of the pellets into the reservoir i.e., the faster the pellets are introduced, the faster the rate of reaction. The reaction can be terminated almost instantaneously by ceasing the introduction of new pellets into the reservoir. It may be further contemplated that the reaction may also be controlled by controlling the flow rate of the liquid oxidizer, alone or in combination with controlled introduction of the pellets.

Although spherical pellets have been described, it should be understood that other configurations of the solid-like mixture may be desirable and may be calibrated to achieve specific control over the reaction. For instance, larger surface areas may be achieved with different shapes for the pellets. In addition, the shape and size of the pellets may be dictated by the manner or mechanism for introduction of the solid-like mixture into the liquid oxidizer. For instance, rod shaped pellets may be better suited for introduction into the reservoir, such as in the manner of control rods for nuclear reactors. In some cases, the pellets may be introduced via a carrier that supports and/or the pellets within the reservoir. In this case, the configuration of the pellets may be modified to provide a supported end while maximizing the exposed surface area for oxidation.

In one specific process, a 75/25 mixture (75% Al+25% Ga by weight) was obtained by raising the temperature of the weight percent liquid-liquid aluminum-gallium mixture above 600° C. in the inert reaction chamber, to point 72 in the equilibrium phase diagram. A controlled rate of cooling converts this equilibrium liquid-liquid solution to the solid-like mixture with microscopic quantities of liquid gallium proximate to the grain boundaries and with little or no macroscopic liquid phase present. This embodiment advantageously reduces the amount of gallium (which is much more expensive than aluminum) required to form the final mixture, but at the cost of a higher initial mixing temperature to achieve the starting point 72 in FIG. 3.

In yet another specific alternative, the composition comprises about 95% (ninety-five percent) aluminum and about 5% (five percent) gallium by weight, as indicated by the point 73 in FIG. 3. Formation of this mixture requires a starting point temperature of about 650° C. This alternative mixture again reduces the amount of gallium required for the solid-like mixture, but at the cost of a higher initial mixing temperature. This alternative mixture pushes the solid-like solution towards the solid phase region 51 of the phase equilibrium diagram upon cooling. This specific mixture advantageously traps microscopic liquid phase gallium in the grain boundaries of the solid-liquid aluminum-gallium phases, which then acts as a suitable solvent to allow the dissolved aluminum to react with water according to equation 1, and ultimately enables the solid-like mixture to continue reacting with the oxidizer until all the available aluminum is consumed.

It is of course recognized that the aluminum in the Al—Ga mixture is the fuel in the reaction of Equation 1 above. Thus, it is desirable to increase the aluminum content of the final mixture. In the specific high Al content embodiments discussed above, high process temperatures are required for the liquid-liquid phase combination of the Al and Ga. According to another embodiment herein, it has been discovered that high aluminum content can be achieved at significantly lower process temperatures to produce a slurry-type mixture. Thus, in this embodiment, an 80/20 mixture (80% Al and 20% Ga by weight) is achieved, as identified by point 80 in FIG. 3. In accordance with this embodiment, one process for forming the 80/20 mixture includes filling a ½ cup stainless steel container with enough liquid gallium to cover the bottom of the container. A ⅔ cup stainless steel container is filled approximately one-third full with liquid gallium. An appropriate amount of solid aluminum (as determined by the desired mixture ratio) is added to the gallium in the second container. In one specific procedure, the solid aluminum was about 10% by weight relative to the gallium. It is noted that varying the weight percent of the aluminum affects the resulting solid particle size. Higher weight percent aluminum tends to yield smaller particle sizes. In accordance with this embodiment, the cooling rate is controlled to assure that the aluminum crystallites that form are polycrystalline rather than single crystal, and further assuring that the resulting product is a mixture of solid aluminum and a liquid phase of gallium proximate to the grain boundaries. It should be understood and appreciated herein that in accordance with such embodiments, a relatively fast cooling rate is generally required.

Since aluminum is buoyant in liquid gallium, the first container was placed within the larger second container on top of the aluminum-gallium composition to encourage intimate contact between the constituents. Again, as explained above, other methods may be employed to insure this intimate contact during the heating cycle. The resulting “melt apparatus” containing the solid aluminum and liquid gallium was heated to 200° C. in a known manner. In one specific embodiment, the heating step was achieved using a hotplate with the melt apparatus probed with a thermocouple to track the melt temperature. Alternatively, the melt apparatus may be placed in a furnace or oven, as discussed above. The melt apparatus was maintained at the target temperature of 200° C. for about one hour to allow the liquid gallium to reach saturation of aluminum. Since the anticipated maximum equilibrium solubility of aluminum in gallium is about 80% by weight Al and 20% by weight Ga, this saturation will yield the 80/20 mixture after cooling.

At the end of the heating cycle, the melt apparatus was removed from the hotplate (or furnace) and was allowed to cool to about 60° C. in preparation for the ensuing process steps. As the melt cools below 30° C., the polycrystalline solid aluminum and liquid gallium spontaneously nucleate into solid particles. It is thus desirable to conduct the ensuing steps at this elevated temperature to insure that the melt will not cool below its freezing point of about 30° C. before the processing is completed. At this point, the composition includes 80/20 Al—Ga solid in liquid gallium to form sludge. The smaller container was removed to allow access to the sludge within the larger container. The sludge is removed and placed in centrifuge tubes that have previously been purged of air and provided with an inert atmosphere. In this specific, the centrifuge tubes had a nitrogen atmosphere to keep oxygen from the melt. The tubes were placed in a centrifuge and spun at 200 rpm for about ten (10) minutes. At the end of the centrifuge cycle, the centrifuge tubes contained a powder or sandy substance on top of the bulk melt at the base of the tubes. This substance constituted the 80/20 Al composition (point 81 in FIG. 3) that was removed for used as a fuel as described above. In the specific example, a stainless steel scoop was used to extract the polycrystalline mixture, although other means for removing the 80/20 composition may be used.

The remaining bulk melt is liquid gallium that can be used in another process. It should be appreciated that the process began with a weight percent of aluminum (10%) that yields a significantly greater weight percent of aluminum (80%) in the final solid-like mixture. Viewed from another angle, the weight percent of the gallium significantly decreases from the beginning of the process (90%) to the final product (20%). The weight of the solid aluminum remains constant throughout the process, but some portion of the weight of the gallium is contained within the solid-like mixture. The remaining gallium is in liquid form and ready for reuse in another process. By way of example, if the process began with 10 lbs. aluminum and 90 lbs. gallium (hence the 10% by weight Al), then the final 80/20 Al product will include the 10 lbs. aluminum, but only 2.5 lbs. gallium. The remaining 87.5 lbs. of gallium is kept at the production facility and need not be transported as part of the fuel.

It was found that this 80/20 Al solid mixture reacted rapidly and robustly when immersed in the liquid oxidizer (water) bath. The energy generation capability of this 80/20 mixture is about three times greater than the 28/72 mixture described above.

One significant benefit of the 80/20 Al solid-like mixture is that a significant amount of the gallium used in the process of forming the mixture is not retained within that mixture, as in the lower aluminum weight percent mixtures. Thus, when the mixture is formed into pellets for use as a fuel, the majority of the weight of the pellets is in the usable aluminum fuel, rather than in the liquid gallium agent that dissolved the aluminum. The gallium used in the production process can be retained and reused at the point of production, rather than having to be extracted and recycled after use of the pellets as fuel. By way of comparison, pellets formed from the 28/72 Al mixture will have roughly three times more gallium than the 80/20 Al mixture. When the 28/72 Al pellets are spent as fuel, the gallium that comprised 72% of the weight of the pellets must be extracted from the emission products of the fuel reaction and returned to the production facility. If the pellet fuel weighs 100 lbs, the recovered gallium will weigh about 72 lbs. On the other hand, when the 80/20 Al mixture pellets are used as fuel, the gallium comprises only about 20 lbs (of a 100 lb. supply of pellets) that must be extracted from the reaction products and recycled. In both cases, about the same amount of liquid gallium is used to produce the pellets, but in the case of the 28/72 Al mixture, most of the gallium weight is retained in the fuel pellets.

As thus far described, and in accordance with certain embodiments herein, the invention provides an Al—Ga alloy in a solid-like mixture that can be immersed in a reagent, such as water, to readily and efficiently produce hydrogen. It has been found that at certain temperatures the Al—Ga fuel pellets can have a relatively slow reaction time once the pellets are immersed in water. In certain experiments, 80/20 Al—Ga fuel pellets cooled to 15-20° C., which is below the Al—Ga alloy freezing/melting point temperature (26.6° C.), took a significant amount of time before the hydrogen-producing reaction began. The speed of initiation of the reaction was increased by heating the water, with the reaction commencing at about 28° C. in the experiments.

In accordance with certain embodiments of the present invention, it is desirable for the hydrogen-producing reaction to commence more quickly and at lower temperatures, such as at room temperature or even as low as near the freezing temperature of water. In accordance with these embodiments, it has been found that the reaction of the solid Al—Ga pellets begins almost immediately when the pellets are in contact with a lower melting point alloy, even when the temperature of the water is below the freezing point of the Al—Ga alloy. Thus, in experiments a quantity of liquid-phase indium-gallium (In—Ga) alloy was added to a quantity of water. An Al—Ga pellet was added to the water with no immediate reaction. However, when the Al—Ga pellet moved into contact with the suspended In—Ga alloy, the hydrogen-producing reaction commenced very rapidly (i.e., in less than three seconds after contact).

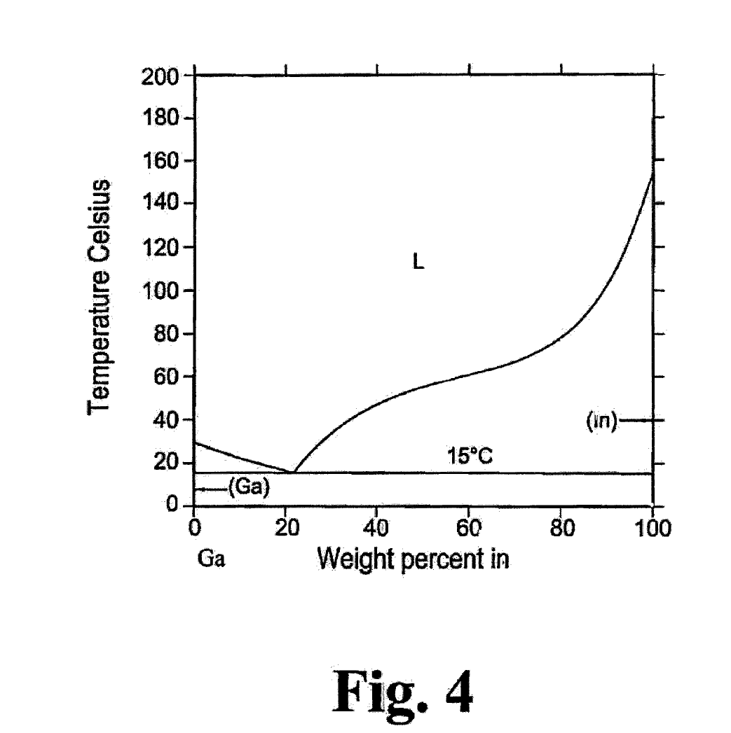

In the specific experiment, the In—Ga alloy included about 80% gallium and about 20% indium, which is near the eutectic point for the alloy. The eutectic line for this alloy is at 15° C., which is below the freezing point of the Al—Ga mixture, as shown in the Ga—In phase diagram in FIG. 4. It can be appreciated from this phase diagram that In—Ga alloys with greater than about 25% indium will likely have no impact on the reaction time and temperature of the Al—Ga pellets because the melting point of a 75/25 Ga—In alloy is about the same as the melting point of the Al—Ga pellets.

In accordance with one aspect of the invention, the solid-like Al—Ga pellets are dissolved in a liquid-phase Ga—In alloy. This solution can then be added to the water reagent to produce the hydrogen-producing reaction. In an alternative embodiment, the fuel pellets may be formed by a combination of the solid-phase Al—Ga with a liquid-phase Al—(Ga—In) alloy. Even when most of the combination is solid phase, the liquid phase component is sufficient to initiate the hydrogen reaction. Once the reaction commences it is self-sustaining until the solid-phase Al—Ga has been consumed. In one specific example, a liquid-phase alloy of 68% Ga, 22% In and 10% Sn was added to an equal mass of aluminum to form a solid-like mixture of about 34% Ga, 11% In, 5% Sn and 50% Al. In this example, the solid-like mixture was cooled in a freezer for about four hours to below 0° C. The solid-like mixture was able to react almost immediately in room temperature water.

In accordance with one specific embodiment, the lower melting point alloy is Ga—In. Other gallium alloys may be acceptable with eutectic lines below the melting point of the Al—Ga pellets. Thus, the Al—Ga pellets may also be dissolved in a gallium-tin (Ga—Sn) alloy since this alloy has a melting point temperature at about 19° C. Similarly, a Ga—In—Sn alloy (which has an equilibrium melting point of about 10° C. or about −20° C. when super cooled) may be used with the present invention. In one specific example, favorable results were obtained with a liquid-phase alloy of 68% Ga, 22% In and 10% Sn.

It is contemplated that other alloys may be acceptable with melting points between the freezing point temperature of water (0° C.) and the melting point temperature of the Al—Ga pellets (about 26.6° C.). In some cases, the freezing point of the water may be lowered by an additive, such as certain salts, so that alloys with melting points below 0° C. may be acceptable, provided the alloys can be readily provided in a liquid phase.

In accordance with certain embodiments, a fuel for splitting water into hydrogen and a hydroxide component comprising an aluminum (Al) rich tin (Sn) alloy is provided. According to this aspect of the invention, the alloy is placed in contact with a liquid mixture of gallium (Ga) and indium (In) and allowed to soak. Thereafter, when water is brought into contact with the Al alloy-Ga, In liquid ensemble, the alloy splits the water into hydrogen, heat, and aluminum hydroxide until nearly all the Al is reacted. In contrast, when either pure Al or commercial alloys not containing Sn are brought into contact with either liquid Ga or liquid Ga, In mixtures and then brought into contact with water, a reaction occurs which stops after the small equilibrium amount of Al that dissolved in the liquid Ga or liquid Ga, In mixture (about 1% by weight Al) reacts with the water. The mechanism is thought to be that because there is Sn in the grain boundaries of the Al, the Ga, In liquid can react with the surface Sn. When water is added, the Sn, Ga, In liquid in the grain boundary continues to dissolve the Al grains, which in turn, reacts with the water until most of the Al has reacted to split the water.

One non-limiting advantage of the present invention is that in contrast to other Al—Ga and Al—(Ga, In, Sn) alloys which will react in water and moist air, the Al—Sn alloys of the present invention are stable in both air and water and will only split water after they have soaked in a liquid Ga, In mixture. Thus, the Al—Sn alloys are safe energy storage materials in air or water. It should also be noted that while liquid gallium, indium and tin alloys have minimal oxidation activity, when aluminum is introduced into the gallium, indium and tin liquid alloys, oxygen will be removed from the gallium oxide on the surface, thereby enabling the indium and tin in the liquid phase to oxidize in air. Indium and tin will oxidize into completion rather than oxidizing only on the surface like gallium.

As will be explained in detail below, when gallium, indium and tin are mixed in specific ratios at or near room temperature, a liquid phase will form approximate to the grain boundaries of the aluminum in the sold-like alloy mixture. This liquid phase, in turn, enables the aluminum to react with water, and particularly in such a manner that streams or channels of the liquid phase gallium, indium and tin alloy will exist between the aluminum rich grains. Though most of the aluminum will be present in the aluminum rich grains, a small amount of aluminum will be dissolved in the liquid phase. The aluminum solvated in liquid phase will be transported to the surface, thereby causing a chemical reaction between the small amount of aluminum in the liquid phase and water. In order to restore equilibrium, aluminum from the aluminum rich grains will diffuse into the liquid phase and continue the reaction once most of the aluminum in the liquid phase is depleted. The reaction between aluminum and water is indicated by the following equation:

2Al+6H₂O→2Al(OH)₃+3H₂ (4)

wherein the total energy released as combustible hydrogen plus heat ΔH°=−861.1 kj.

In accordance with one aspect of the present invention, a composition comprising 90% by weight Al, 6.8% by weight Ga, 2.2% by weight Sn, and 1.0% by weight In was dropped into a 250 ml crystallization dish of seawater at room temperature. Immediately after the alloy was dropped into the seawater, hydrogen bubbles started to appear on the entire surface of the alloy. The alloy disintegrated into small pieces while continuing to react with the seawater. After the reaction ended, the remnants were observed, which turned out to be fine powder. The fine powder was denser than seawater and stayed at the bottom of the crystallization dish. Following the same procedure, the alloy was also tested in seawater at 30° C. and 60° C. and produced the same results.

In accordance with another non-limiting and illustrative experiment in accordance with the present invention, a 97% by weight aluminum, 3% by weight gallium single crystal sample was prepared to determine whether the alloy will react with water near the gallium melting point of approximately 30° C. if gallium is present in the aluminum grain boundaries. The alloy was dropped into water and temperature was raised from 20° C. to 80° C. No reaction was observed.

A 90% by weight aluminum, 6.8% by weight gallium, 1.0% by weight indium and 2.2% by weight tin sample was also prepared, wherein the aluminum used in the alloy was PL 1020, which is composed of 99.7% by weight aluminum, 0.2% by weight iron and 0.1% by weight silicon. At room temperature, the alloy reacted well with tap water and distilled water. This reaction was enabled via microscopic streams of liquid phases composed of gallium, indium and tin. According to its ternary phase diagram, the mixture of gallium, indium and tin has a melting point of 10° C. at its eutectic. As such, if the alloy was dropped into cold water near 0° C., it was expected that the stream of liquid phase would freeze and no reaction would occur. With such set-up, the experiment was repeated 4 times varying the mass of the alloy as indicated in Table 2.

TABLE 2

| Mass | Result |
|---|---|
| 2.534 g | No Reaction |
| 3.463 g | No Reaction |
| 1.275 g | No Reaction |
| 2.437 g | No Reaction |

As expected, no reaction was observed. Nevertheless, there were bubbles observed in the initial stage which stopped within about 5 to 10 seconds. This is most likely due to the delay while the liquid phases were solidifying.

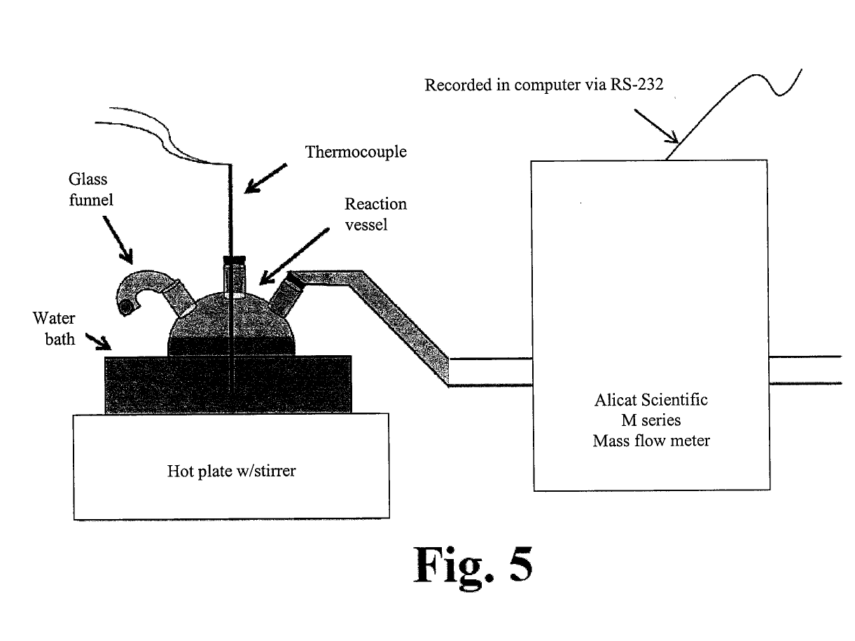

Reaction rate was measured under an airtight environment using the apparatus shown in FIG. 5. The apparatus consisted of a 125 mL three-neck flask for containing the alloy-water reaction which delivered H₂ to the 50 mL inverted eudiometer. H₂ was delivered by means of tubing, and a water reservoir beneath the eudiometer supported a column of water within the eudiometer. The water in eudiometer and the water reservoir beneath it were all maintained at 20° C.

An alloy ranging from approximately 0.028 g to 0.045 g was placed in the left-hand side funnel. The water in the three neck flask was pre-heated to a desired temperature before testing. Temperature was measured via the thermocouple installed on the middle neck. To help maintain a constant temperature within the flask, the water bath outside the flask was also pre-heated to the desired temperature.

Reaction of the alloy was initiated by rotating the funnel in order to drop the alloy into the water inside the three neck flask. Depending on the experiment, the three-neck flask contained either distilled water or seawater.

H₂ produced from the reaction then displaced the water column in the inverted eudiometer. A differential pressure transducer recorded the change in pressure relative to barometer readings of the laboratory ambient pressure. These differential pressure readings were in turn read by a NI USB-6009 converter into a computer. Temperature was read and recorded using NI USB TC-01.

TABLE 3

| Water Type | Water Temperature |
|---|---|
| Distilled Water | 20° C. |
| Distilled Water | 30° C. |
| Distilled Water | 40° C. |
| 3.5% by weight sea saltwater | 20° C. |
| 3.5% by weight sea saltwater | 30° C. |
| 3.5% by weight sea saltwater | 40° C. |

From pressure difference and temperature measurement, the amount of hydrogen produced was calculated. To minimize error of the measurement, water vapor and air inside the system were taken into account during the measurement.

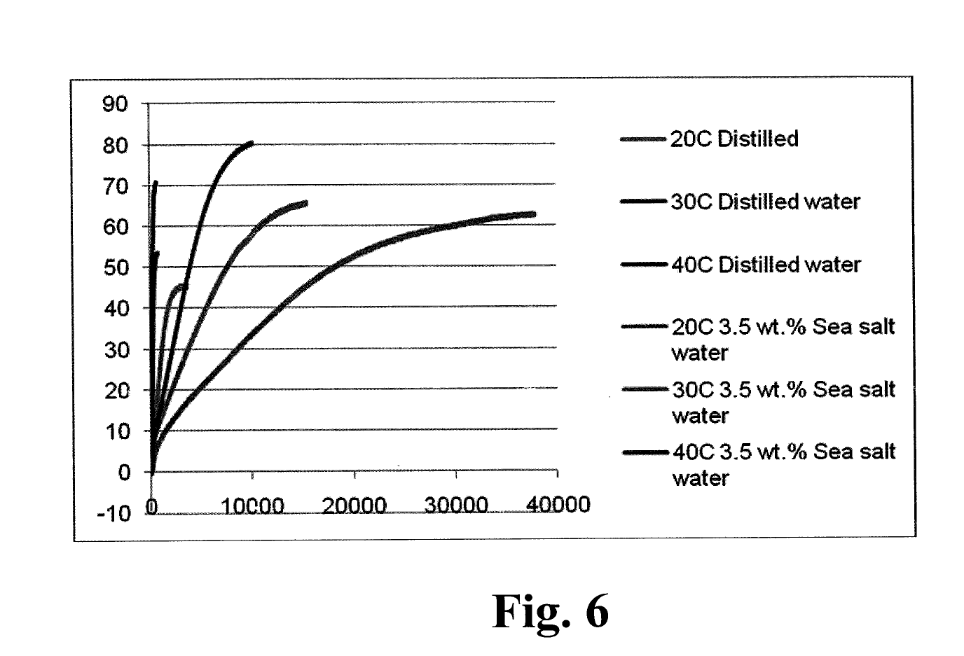

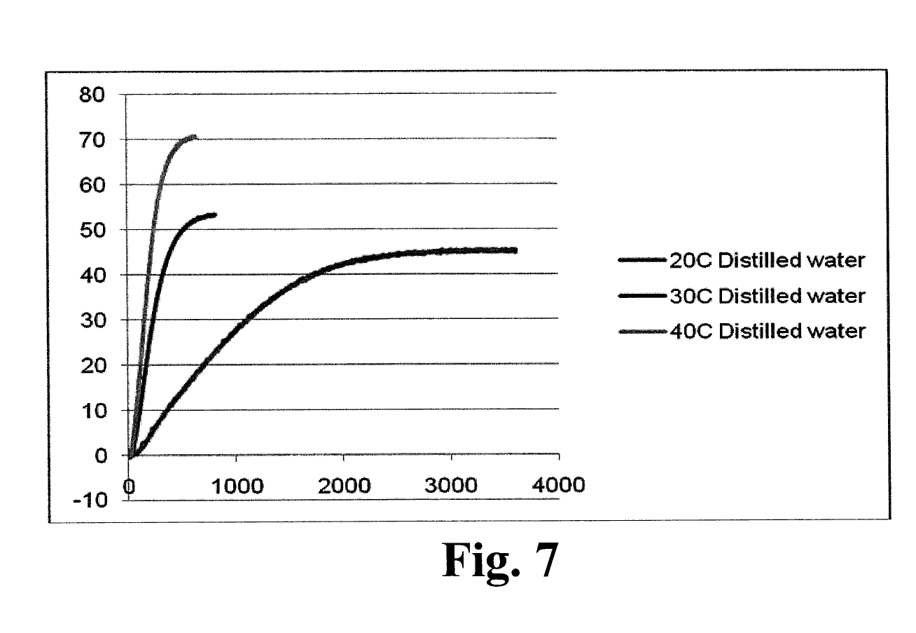

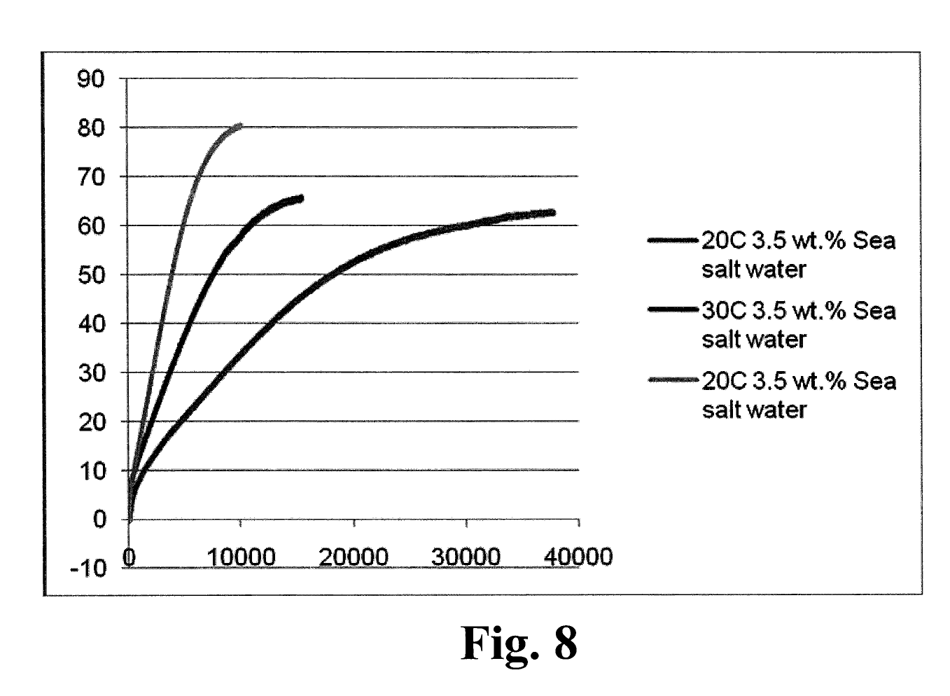

Yield versus time was plotted in FIGS. 6, 7 and 8. FIG. 6 compares all the data points including both 3.5% by weight sea saltwater and distilled water reactions. FIG. 7 indicates only a distilled water reaction, and FIG. 8 represents only the sea saltwater reaction. Yield was calculated considering the case where all Al had reacted was 100% yield.

With a higher temperature, higher yield and faster reaction rates were achieved for the same type of water (i.e. 40° C. distilled water reaction was faster with higher yield than a 20° C. distilled water reaction). Also, a 3.5% by weight sea saltwater sample, which was made to emulate seawater, had a slower reaction but produced a higher yield than the distilled water reaction for the same temperature (i.e. a 20° C. 3.5% by weight sea saltwater reaction had a slower reaction rate but had a higher yield than 20° C. distilled water reaction).

The microstructure of the alloys was studied using FEI Quanta 3D FEG Scanning Electron Microscope (SEM) and Oxford INCA Xstream-2 with Xmax80 detector for Energy Dispersive X-ray spectroscopy (EDX) analysis.

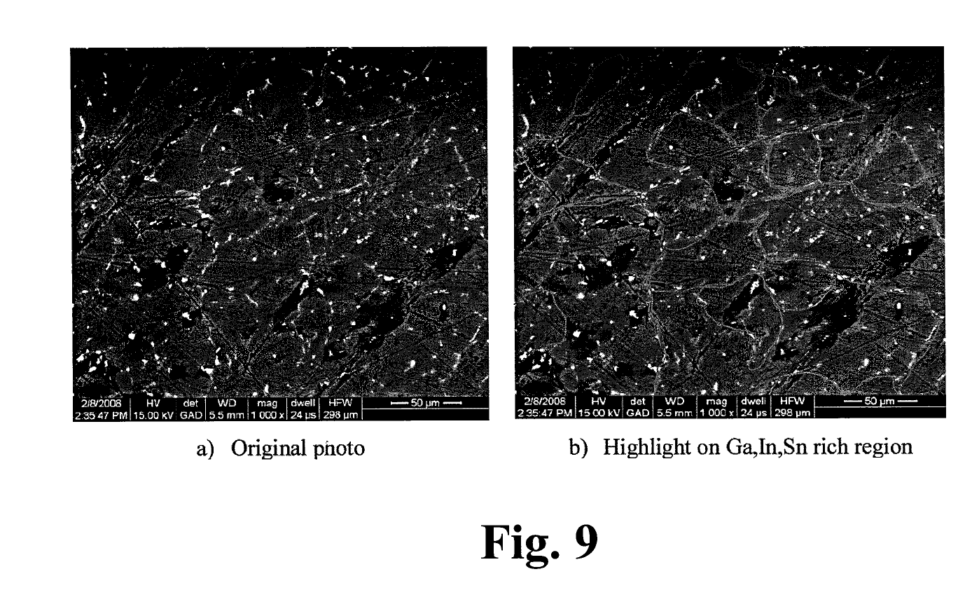

FIGS. 9a and b are images of 95% by weight aluminum, 3.4% by weight gallium, 1.1% by weight indium and 0.5% by weight tin alloy microstructures (FIG. 9a is the original image, while FIG. 9b is highlighted to show the regions rich in gallium, indium and tin). Phase segregation is observed between grains and white lines. EDX results show that the white lines are mainly composed of gallium, indium and tin. In previous qualitative experiments, it has been shown that the gallium, indium and tin alloy will freeze when ice water is poured on it, even at its eutectic composition (i.e., 68% by weight gallium, 22% by weight indium and 10% by weight tin). Also, frozen alloys were shown not to react with water. Since the alloy reacts with water at room temperature, it is possible that these streams of gallium, indium and tin rich regions are in a liquid phase where the primary reaction occurs.

Additional advantages and improvements of the processes, methods and compositions of the present invention are further demonstrated within the following examples. These examples are illustrative only and are not intended to limit or preclude other embodiments of the present invention. Before describing the illustrative examples in detail, it should be understood and appreciated herein that altering the cooling rate used in accordance with the methods and processes of the present invention will influence the resulting microscopic liquid phase streams or channels that exist between the aluminum rich grains. For instance, when the metal is cooled slowly, bigger grains and channel gaps are created. In contrast, when the metal is cooled quickly, more channels are created, yet these channels are smaller in size. To this end, it should be understood that broader liquid phase streams or channels will enable faster reaction rates to occur. In addition, the number of streams in the liquid phase will directly influence how much yield will be achieved. For instance, if the sample is cooled slowly, it will react quickly, yet produce a lower yield. On the other hand, if the sample is cooled quickly, it will reach slower and produce a higher yield.

In terms of the cooling rate associated with the methods and processes of the present invention, it should be understood and appreciated herein that both cast cooling and splat cool-like processes may be used. To this end, a cast cooling process will typically take from about 5 to about 10 minutes to cool down the sample to room temperature, while a splat cool-like process will take from about 1 to about 2 minutes to cool down. If a faster reaction rate is desired, a cast cooling process would be particularly useful in accordance with the presently described methods and processes. On the other hand, if achieving a maximum yield (as opposed to a quick reaction) is desired, a splat cool-like process would be particularly useful.

### Example 1

This example illustrates the fabrication of various alloys (listed in Table 4 below) in accordance with the principles of the present invention.

TABLE 4

| Metal | Purity | Vendor |
|---|---|---|
| Aluminum | 99.99% | Alfa Aesar #43428 |
| Gallium | 99.99% | Recapture Metals |
| Indium | 99.999% | Alfa Aesar #14720 |
| Tin | 99.99% | Atlantic Metals & Alloys |

Fabrication is done by means of melting and splat or cast cooling. Aluminum pallets are placed in an aluminum oxide crucible and then placed in an air free furnace by purging the furnace with continuous nitrogen or argon gas flow to prevent oxidation. The temperature is increased from room temperature to 700° C. Once the temperature reaches 700° C., the aluminum pallets (inside their crucibles) are left inside the furnace for one to two hours to completely melt all the pallets and make one single piece of aluminum. Once all aluminum pallets are melted and become one piece, the furnace is turned off so that the piece can reach room temperature.

Gallium is then melted in a beaker, plastic container or stainless steel container above 30° C. or higher. Indium and tin are added into the liquid gallium to create a homogenous liquid metal alloy of gallium-indium-tin. The gallium-indium-tin liquid metal is then poured on top of the aluminum.

The crucible containing the aluminum and liquid metal alloy is then placed back into the air free furnace, and the temperature is increased from room temperature to 700° C. at a rate of 10° C. per minute. Once the temperature reaches 700° C., the metals (inside their crucibles) are left inside the furnace for 10 hours or more (e.g., up to 24 hours). At 700° C. all metals, aluminum, gallium, indium and tin are melted.

After this time has passed, the samples are taken out of the furnace and splat cooled on a stainless steel plate (e.g., poured and spread out on the plate as thinly as possible) that is kept as cool as possible and has quarter inch copper pipes installed on its bottom (i.e., water (at 17° C.) is continuously flowed through the copper pipes to cool the sample). The aluminum alloy is cooled back to room temperature within 1 or 2 minutes.

Various samples fabricated in accordance with the above procedure are listed in Table 5 below.

TABLE 5
Composition

80% by weight aluminum, 13.6% by weight gallium,
4.4% by weight indium, 2% by weight tin
50% by weight aluminum, 34% by weight gallium,
11% by weight indium, 5% by weight tin
90% by weight aluminum, 6.8% by weight gallium,
2.2% by weight indium, 1% by weight tin
95% by weight aluminum, 3.4% by weight gallium,
1.1% by weight indium, 0.5% by weight tin
95% by weight aluminum, 3.4% by weight gallium,
1.1% by weight tin, 0.5% by weight indium
67.56% by weight gallium, 21.83% by weight indium,
9.93% by weight tin, 0.68% by weight aluminum
67.56% by weight gallium, 21.83% by weight tin,
9.93% by weight indium, 0.68% by weight aluminum

Tests were only conducted at room temperature in both distilled water and seawater. In terms of maximum yield, there was very little difference between the distilled water reaction and the seawater reaction. However, a qualitative observation indicated that there was a faster reaction in the distilled water.

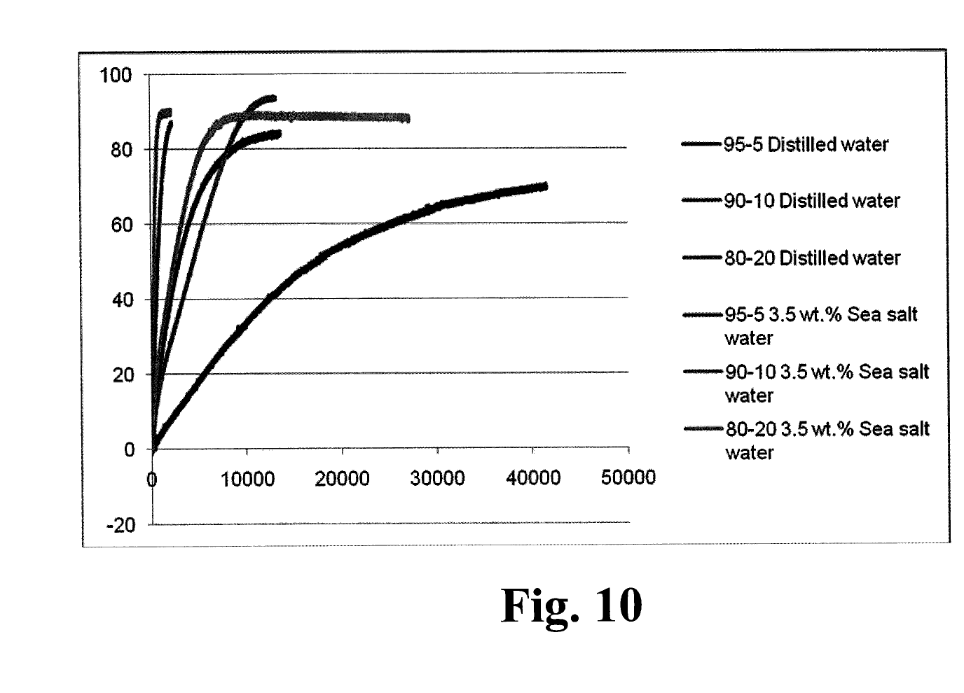

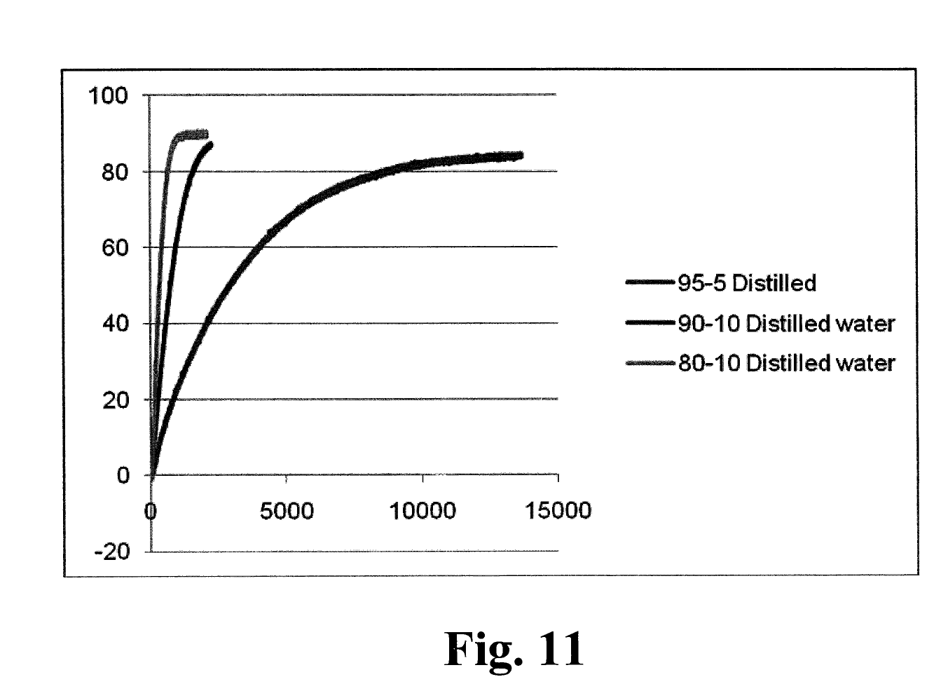

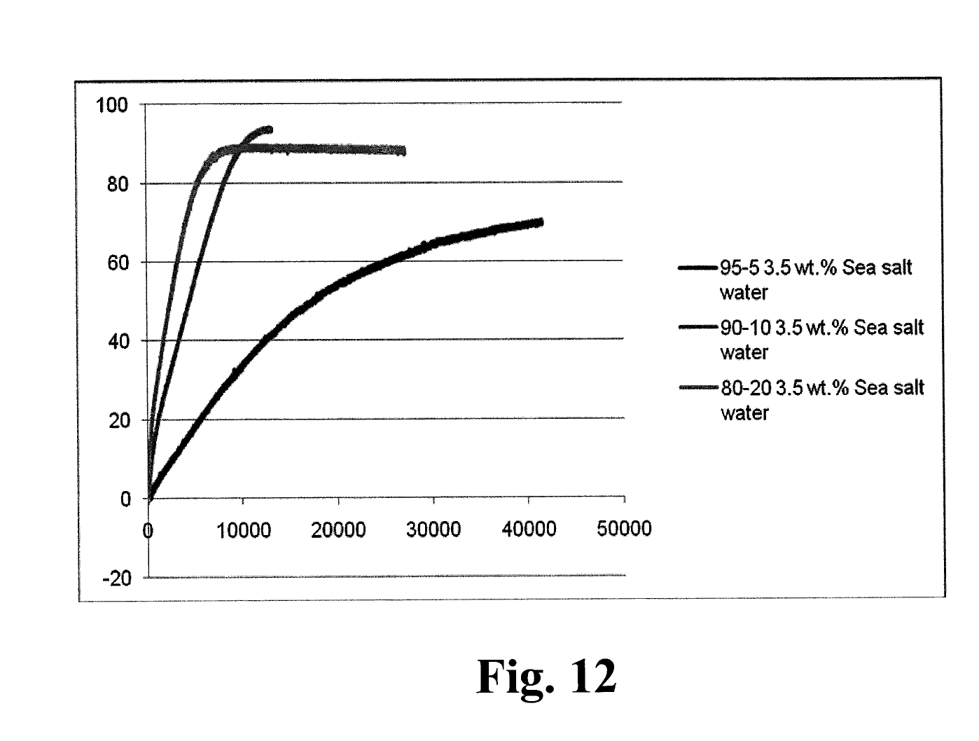

Yield versus time was plotted in FIGS. 10, 11 and 12. Similar to the cast cooled sample having 90% by weight aluminum, 6.8% by weight gallium, 2.2% by weight tin and 1.0% by weight indium, the overall speed of the reaction was faster in distilled water. In terms of the resulting yield, the sample with 90% by weight aluminum, 6.8% by weight gallium, 2.2% by weight indium and 1.0% by weight tin had higher yield in saltwater. On the other hand, the 80% by weight aluminum and 95% by weight aluminum samples had lower yields when reacted in saltwater. All alloys tested for this particular quantitative data were splat cooled.

Data regarding higher gallium content alloys, 0.68% by weight aluminum and 50% by weight aluminum samples were tested qualitatively. It was observed that the reaction produced hydrogen and heat. Samples will be tested to gather quantitative results in the near future.

### Example 2

This example illustrates an Al—Sn alloy fabrication method in accordance with the principles of the present invention.

In accordance with this illustrative example, fabrication is done by means of melting and splat or cast cooling. Aluminum pallets are placed in an aluminum oxide crucible and then placed in an air free furnace by purging the furnace with continuous nitrogen or argon gas flow to prevent oxidation. The temperature is increased from room temperature to 700° C. Once the temperature reaches 700° C., the aluminum pallets (inside their crucibles) are left inside the furnace for one to two hours to completely melt all the pallets and make one single piece of aluminum. Once all aluminum pallets are melted and become one piece, the furnace is turned off so that the piece can reach room temperature.

Tin is placed on top of the aluminum in a ratio of 90:10 Al:Sn, and the crucible containing the aluminum and tin alloy is then placed back into the air free furnace, and the temperature is increased from room temperature to 900° C. at a rate of 10° C. per minute. Once the temperature reaches 900° C., the alloys (inside their crucibles) are left inside the furnace for 10 hours or more (e.g., up to 24 hours). At 900° C., all metal, aluminum and tin are melted.

After this time has passed, the samples are taken out of the furnace and splat cooled on a stainless steel plate (e.g., poured and spread out on the plate as thinly as possible) that is kept as cool as possible and has quarter inch copper pipes installed on its bottom (i.e., water (at 17° C.) is continuously flowed through the copper pipes to cool the sample). The aluminum alloy is cooled back to room temperature within 1 or 2 minutes.

Gallium (in an amount of about three (3) times that of the aluminum) is then melted in a beaker, plastic container or stainless steel container above 30° C. or higher. Indium is then added to the melted gallium to create a uniform liquid metal alloy of gallium-indium. The ratio of Ga:In should be 87:13. The aluminum-tin alloy is then placed on top of the liquid metal alloy of gallium-indium. After a few minutes, water is added to react with the alloy.

Qualitative studies have shown that hydrogen and heat was produced due to the reaction. After the reaction, aluminum hydroxide and liquid gallium-indium alloy were visible.

### Example 3

In accordance with another non-limiting and illustrative experiment, a rod-shaped Al rich alloy composed of 98 wt % Al, 2 wt % Sn was prepared. This alloy weighed approximately 5 g. Separately, a liquid alloy composed of 15 g of Ga and 4 g of In was prepared in a 250 ml crystallization dish. The crystallization dish was placed on top of a hotplate that was set at 60° C. The Al rich alloy was then placed on top of the liquid alloy inside the crystallization dish. The Al rich alloy was left to soak for approximately 3 hours. Then room temperature water, measured approximately 19° C., was poured into the crystallization dish. The reaction occurred instantly by generating bubbles on the entire surface of the alloy. After the reaction stopped, it was observed that no original form of the alloy was found. Similar experiments were conducted with the same set-up, but varying the amount of time the Al rich alloy was soaked in the liquid alloy. Insofar, starting from 3 hours down to 45 min of soaking time has been analyzed, and has produced the same result.

While an exemplary embodiment incorporating the principles of the present invention has been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A composition for splitting water into hydrogen and a hydroxide component, the composition comprising a solid-state component including at least one of aluminum and tin and a liquid metal alloy that is capable of at least partially dissolving the solid-state component, the liquid metal alloy including at least one of gallium and indium.

2. The composition of claim 1, wherein the liquid metal alloy comprises between about 70% and about 100% by weight gallium and up to about 30% by weight indium.

3. The composition of claim 1, wherein the solid-state component has a grain boundary region and comprises between about 0.68% to about 95% by weight solid aluminum grains, and wherein the liquid metal alloy is proximate to the grain boundary region of the solid-state component and comprises between about 3.4% to about 67.56% by weight gallium, from about 1.1% to about 11% by weight indium and from about 0.5% to about 21.83% by weight tin.

4. The composition of claim 3, wherein the solid-state component comprises 80% by weight solid aluminum grains and wherein the liquid metal alloy comprises 13.6% by weight gallium, 4.4% by weight indium and 2% by weight tin.

5. The composition of claim 1, wherein the hydroxide component is aluminum hydroxide.

6. The composition of claim 3, wherein the water is seawater or freshwater.

7. An energy storage and on-demand hydrogen and energy generation process comprising:
mixing aluminum with tin to form a solid-state component;
soaking the solid-state component in a liquid metal alloy containing at least one of gallium and indium to form a liquid-solid ensemble;
introducing water to the liquid-solid ensemble to cause hydrogen to be produced; and
collecting the produced hydrogen.

8. The process of claim 7, wherein the water introduced to the liquid-solid ensemble is at a temperature of from about 10° C. to about 90° C.

9. The process of claim 7, further comprising forming the liquid metal alloy by mixing between about 70% and about 100% by weight gallium with and up to about 30% by weight indium.

10. An energy storage and on-demand hydrogen and energy generation process, the process comprising:
mixing aluminum with tin to form a solid-state component;
partially dissolving the solid-state component in a gallium-indium alloy catalyst; and
forming hydrogen, heat and a hydroxide of the solid-state component by introducing water to the partially dissolved solid-state component.

11. The process of claim 10, wherein the water has a temperature of from about 10° C. to about 90° C.

12. The process of claim 10, wherein the gallium-indium alloy catalyst is composed of from about 70% to about 100% by weight gallium and up to about 30% by weight indium.

13. An on-demand process for generating energy by splitting water into hydrogen and a hydroxide component, the process comprising:
forming a liquid phase alloy component by mixing together about 13.6% by weight gallium, about 4.4% by weight indium and about 2.0% by weight tin;
forming a solid-like alloy by mixing about 80% by weight aluminum with the liquid phase alloy component;
adding the solid-like alloy to water at a temperature of from about 10° C. to about 90° C. to cause hydrogen to be produced; and
collecting the produced hydrogen.

14. The process of claim 13, wherein the hydroxide component is aluminum hydroxide.

15. The process of claim 13, wherein the water is seawater or freshwater.

16. A composition for splitting water into hydrogen and a hydroxide component, the composition comprising a solid-state component having from about 0.68% to about 95% by weight solid aluminum grains and a liquid metal alloy having from about 3.4% to about 67.56% by weight gallium, from about 1.1% to about 11% by weight indium and from about 0.5% to about 21.83% by weight tin.

17. The composition of claim 16, wherein the solid-state component comprises 80% by weight solid aluminum grains and the liquid metal alloy comprises 13.6% by weight gallium, 4.4% by weight indium and 2% by weight tin.

18. The composition of claim 16, wherein the hydroxide component is aluminum hydroxide.

19. The composition of claim 16, wherein the water is seawater or freshwater.

20. The composition of claim 16, wherein the liquid metal alloy is proximate to a grain boundary region of the solid-state component.
